(19) United States
(12) Patent Application Publication
(10) Pub. No.: US 2012/0217800 A1
(43) Pub. Date: Aug. 30, 2012

(54) SOLAR POWER SYSTEMS OPTIMIZED FOR USE IN COMMUNICATIONS NETWORKS

(75) Inventors: James Joseph Heidenreich, Bellingham, WA (US); Pankaj H. Bhatt, Bellingham, WA (US)

(73) Assignee: ALPHA TECHNOLOGIES INC., Bellingham, WA (US)

(21) Appl. No.: 13/370,210

(22) Filed: Feb. 9, 2012

Related U.S. Application Data
(60) Provisional application No. 61/442,132, filed on Feb. 11, 2011.

(51) Int. Cl. H02J 4/00

(52) U.S. Cl. 307/26

(57) ABSTRACT

A power system supplies electrical power to at least one load of a communications system. A rectifier module generates a first DC signal based on the utility power signal. A charge control system generates a second DC signal based on the solar power signal. A DC bus is operatively connected to the first DC signal, the second DC signal, and the battery power signal. A distribution module supplies power to the primary load based on the second DC signal when the solar power signal falls within a first operating range and at least one of the first DC signal and the second DC signal when the solar power signal falls outside of the first operating range and a combination of the first DC signal and the second DC signal falls within a second operating range.

### RELATED APPLICATIONS

This application (Attorney Docket P216901) claims benefit of priority to U.S. Provisional Patent Application Ser. No. 61/442,132, filed Feb. 11, 2011.

The contents of all related application(s) listed above are incorporated herein by reference.

### TECHNICAL FIELD

The present invention relates to the generation of electricity using solar panels and, more specifically, to systems and methods for allowing solar panels to operate with optimized efficiency in communications networks.

### BACKGROUND

Solar panels convert solar energy into electricity. A solar panel typically comprises one or more solar cells mounted within a panel structure. Typically, the panel structure defines a panel surface configured such that sunlight reaches the solar cells supported by the panel structure.

Solar panels are often associated with a physical structure containing an electrical load. Typically, solar panels are configured such that the power generated by the solar panels augments power supplied by a primary source such as an electric utility.

When the electrical load consumes more power than can be supplied by the solar panels, power is obtained from the primary source. When the electrical load requires less power than can be supplied by the solar panels, the excess power generated by the solar panels is supplied to the primary source. The operator of the facility including the solar panels is typically credited or otherwise paid for such excess power generated by the solar panels.

The need exists for improved systems and methods of supplying power generated by solar panels to electrical loads and, in particular, to solar panels used to provide power to electrical loads forming part of a communications network.

### SUMMARY

The present invention may be embodied as a power system for supplying electrical power to at least one load of a communications system based on at least one of a utility power signal, a solar power signal, and a battery power signal. The power system comprises a rectifier module, a charge control system, a DC bus, and a distribution module. The rectifier module generates a first DC signal based on the utility power signal. The charge control system generates a second DC signal based on the solar power signal. The first DC signal, the second DC signal, and the battery power signal are operatively connected to the DC bus. The distribution module is operatively connected to the DC bus and a primary load of the communications system. The distribution module supplies power to the primary load based on the second DC signal when the solar power signal falls within a first operating range, at least one of the first DC signal and the second DC signal when the solar power signal falls outside of the first operating range and a combination of the first DC signal and the second DC signal falls within a second operating range, at least one of the second DC signal and the battery power signal when the solar power signal falls within the first operating range and the combination of the first DC signal and second DC signal falls outside the second operating range, and the battery power signal when the solar power signal falls outside the first operating range and the combination of the first DC signal and second DC signal falls outside the second operating range.

The present invention may also be embodied as a method of supplying electrical power to at least one load of a communications system based on at least one of a utility power signal, a solar power signal, and a battery power signal, comprising the following steps. A first DC signal is generated based on the utility power signal. A second DC signal is generated based on the solar power signal. The first DC signal, the second DC signal, and the battery power signal are operatively connected to a DC bus. Power is supplied to the primary load based on the second DC signal when the solar power signal falls within a first operating range, at least one of the first DC signal and the second DC signal when the solar power signal falls outside of the first operating range and a combination of the first DC signal and the second DC signal falls within a second operating range, at least one of the second DC signal and the battery power signal when the solar power signal falls within the first operating range and the combination of the first DC signal and second DC signal falls outside the second operating range, and the battery power signal when the solar power signal falls outside the first operating range and the combination of the first DC signal and second DC signal falls outside the second operating range.

The present invention may also be embodied as a communications system comprising a plurality of power systems each located at least one of a plurality of communications facilities each comprising at least one load. The communications system comprises a photovoltaic system, a battery system, a rectifier system, a charge control system, a DC bus, and a distribution module. The photovoltaic system generates a solar power signal. The battery system generates a battery power signal. The rectifier module generates a first DC signal based on a utility power signal. The charge control system generates a second DC signal based on the solar power signal. The DC bus is operatively connected to the first DC signal, the second DC signal, and the battery power signal. The distribution module is operatively connected to the DC bus and a primary load of the communications system. The distribution module supplies power to the primary load based on the second DC signal when the solar power signal falls within a first operating range, at least one of the first DC signal and the second DC signal when the solar power signal falls outside of the first operating range and a combination of the first DC signal and the second DC signal falls within a second operating range, at least one of the second DC signal and the battery power signal when the solar power signal falls within the first operating range and the combination of the first DC signal and second DC signal falls outside the second operating range, and the battery power signal when the solar power signal falls outside the first operating range and the combination of the first DC signal and second DC signal falls outside the second operating range.

### BRIEF DESCRIPTION OF DRAWINGS

FIG. 1 is a block diagram of an example communications system using a power system of the present invention;

FIG. 2 is a block diagram of the example power system depicted in FIG. 1;

FIG. 3 is a block diagram illustrating details of an example photovoltaic system and an example charge control system that may be used by the example power system of FIGS. 1 and 2;

FIG. 4 is a block diagram depicting the interconnection of solar panels to form the example photovoltaic system depicted in FIG. 3; and

FIG. 5 is a block diagram depicting the example charge control system depicted in FIG. 3.

### DETAILED DESCRIPTION

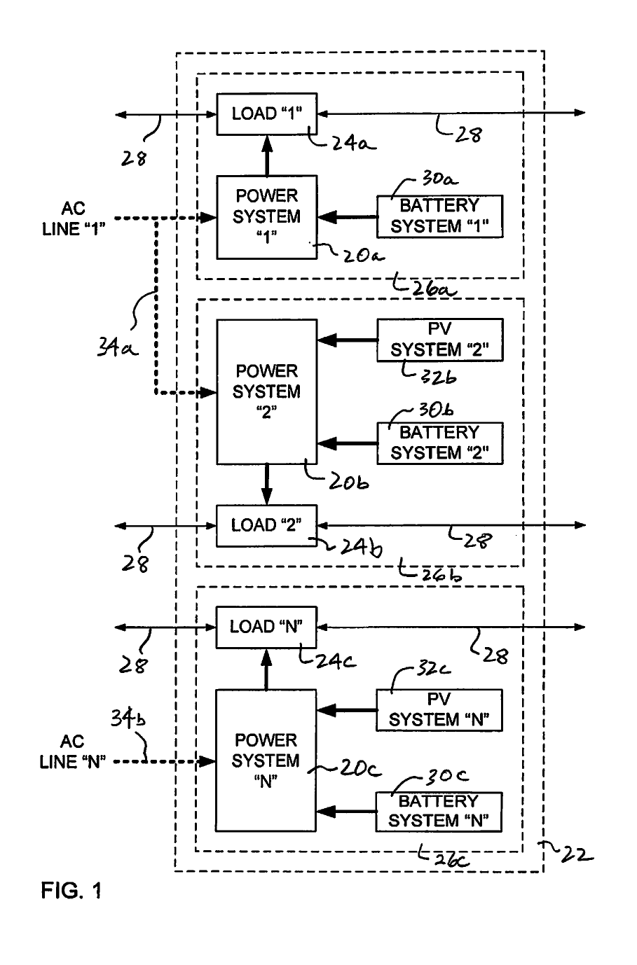

Referring initially to FIG. 1 of the drawing, depicted therein is a block diagram depicting a plurality of power systems 20 constructed in accordance with, and embodying, the principles of the present invention. The example power systems 20 depicted in FIG. 1 are illustrated as part of a communications network 22 further comprising load systems 24 installed at facilities 26. The load systems 24 carry, process, transmit, and/or repeat communications signals on communications lines 28, and the power systems 20 are configured to provide electrical power to the load systems 24.

It should be recognized that the example communications network 22 depicted in FIG. 1 is described as a simplified example of a communications network. Any particular communications network will likely differ from the example communications network 22. In any event, the details of the example load systems 24 of the example communications network 22 are or may be conventional and will not be described herein beyond that extent helpful for a full understanding of the present invention.

In addition, the present invention is of particular significance when the load systems 24 are part of a larger communications network; for example, the load systems 24 may represent the load of the head end of a CATV system. The present invention will be described herein primarily in the context of a CATV system, with the understanding that the scope of the present invention has application to other communications systems with similar load requirements.

As will be explained in further detail below, the example power systems 20 contain certain common elements but are constructed in a modular fashion to allow the power systems 20 to accommodate load systems 24 with varying parameters and also to accommodate assets, such as battery systems 30 and photovoltaic systems 32, located at the facilities 26. Another type of asset available at each of the facilities 26 are AC utility lines 34 represented by dashed lines in FIG. 1.

Accordingly, the example communications network 22 comprises three power systems 20a, 20b, and 20c installed at separate facilities 26a, 26b, and 26c to provide power to load systems 24a, 24b, and 24c within the communications network 22. And, in the example communications network 22, the first, second, and third example power systems 20a, 20b, and 20c are adapted to be used in conjunction with first and second battery systems 30a, 30b, and 30c, respectively, while the second and third power systems 20b and 20c are also adapted to be used in conjunction with first and second photovoltaic systems 32a and 32b, respectively. A first AC utility line 34a is available to the first and second power systems 20a and 20b, while a second AC utility line 34b is available to the third power system 20c.

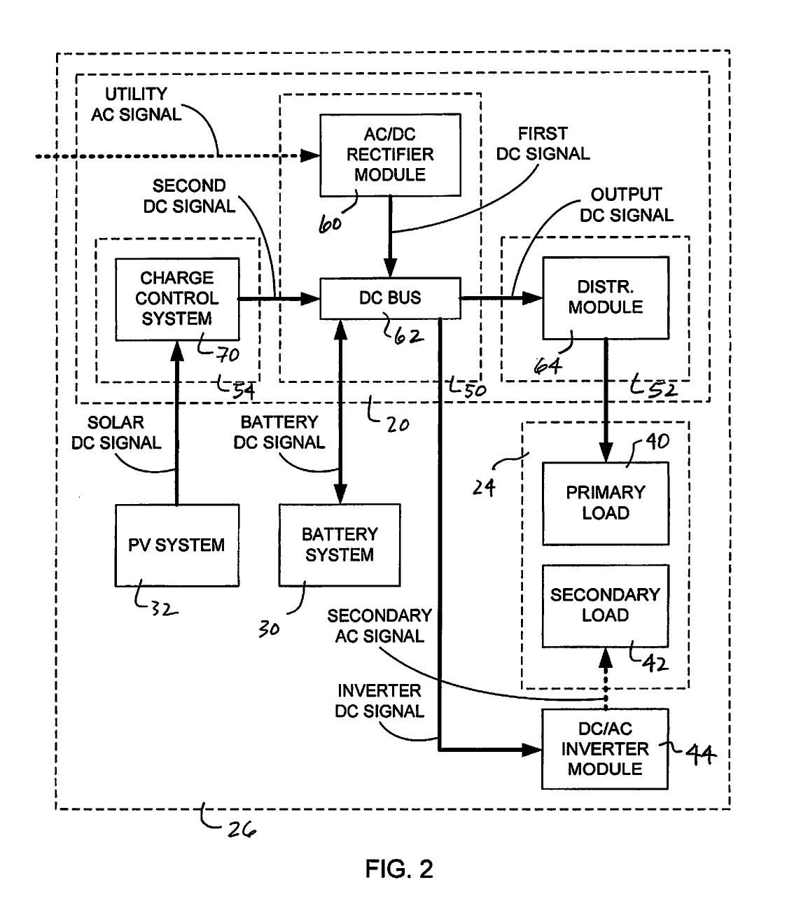

Referring now to FIG. 2 of the drawing, the details of the example power systems 20 will now be described in further detail. FIG. 2 illustrates that each of the example load systems 24 comprises a primary load 40 and, optionally, a secondary load 42. If power is to be supplied to the secondary load 42, the power system 20 is further used in conjunction with a DC/AC inverter module 44.

FIG. 2 also illustrates that the example power systems 20 may be configured to comprise a rectifier bay 50, a distribution bay 52, and a solar bay 54. The rectifier bay 50 comprises one or more AC/DC rectifier modules 60 and a DC bus 62. Each AC/DC rectifier module 60 generates a first DC power signal based on a utility AC power signal supplied by a utility or other primary source. The first DC power signal is applied to the DC bus 62. The distribution bay 52 comprises a distribution module 64 containing circuit breakers (not shown) as necessary to isolate the primary load 32 when desired. The rectifier module(s) 60, DC bus 62, and distribution module 64 are or may be conventional and will not be described herein in further detail.

In the example power system 20, the battery system 30 is also operatively connected to the DC bus 62. The batteries (not shown) forming the example battery system 30 are or may be conventional and will not be described herein beyond what is helpful to a complete understanding of the present invention. While a battery system need not be provided for each of the load systems 24 of the communications system 22, a battery system will typically be provided for each of the loads of a typical communications system critical to operation of that communications system.

The solar bay 54 contains a charge control system 70 adapted to generate a second DC power signal based on a solar DC power signal generated by the photovoltaic system 32. The second DC power signal is also applied to the DC bus 62. The parameters of the example charge control system 70 are predetermined such that a voltage level of the second DC power signal is lower than a voltage level of the solar DC power signal and higher than a voltage level of the first DC power signal when the photovoltaic system 32 is generating the solar DC power signal.

Accordingly, when the photovoltaic system 32 is generating the solar DC power signal, any power generated by the photovoltaic system 32 is supplied to the load system 24. Power to the load system 24 is supplied by the utility AC power signal through the AC/DC rectifier module(s) 60 only when the solar DC power signal is not present or is insufficient to meet the requirements of the loads 40 and/or 42. When the power generated by the one or both of the photovoltaic system 32 and the AC/DC rectifier module(s) 60 is sufficient to satisfy the power requirements of the load system 24, the battery system 30 is charged. When the combination of the power supplied by the photovoltaic system 32 and the AC/DC rectifier module(s) 60 is not sufficient to satisfy the power requirements of the load system 24, a battery DC power signal generated by the battery system 30 supplies power to the load system 24.

With the foregoing general understanding of the construction and operation of the present invention in mind, the details of the example power system 30 will now be described in further detail.

The power system 30, primary load 32, optional secondary load 42, photovoltaic array 40, battery array 42, and optional DC/AC inverter module 44 will normally be installed at a single one of the facilities 26 within the network 22.

In the example communications network 22, the primary load 40 will typically be CATV and/or telecommunications equipment that operates on a DC voltage. The primary load 40 typically represents the most critical load at each of the facilities 26, and the power system 20 is configured to provide power to the primary load 40 as the highest priority.

A typical facility 26 will further comprise additional loads that operate on conventional utility AC power. Examples of the additional AC loads that may be found at a typical facility in a communications network include lighting, HVAC systems, and the like. The most critical of these AC loads may optionally be represented as the secondary loads 42, and the example power system 20 is configured to supply power to these secondary loads 42 at the highest priority. If any of the AC loads present at a facility are designated as secondary loads 42, the DC/AC inverter module 44 is provided to generate a secondary AC power signal based on an inverter DC signal.

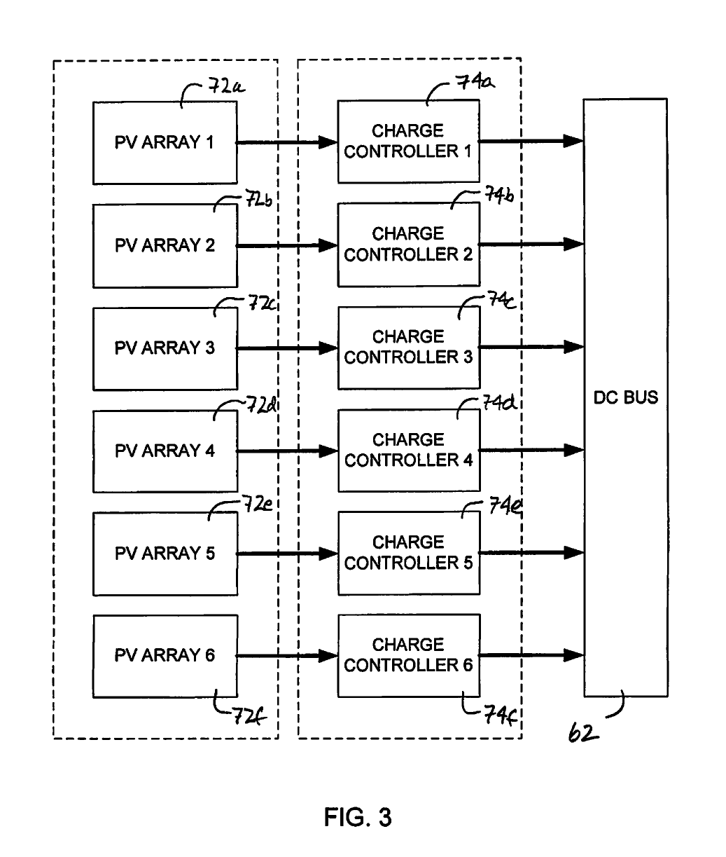

Referring now to FIG. 3 of the drawing, the example photovoltaic system 32 and example charge control system 70 will be described in further detail. As generally described above, the power system 20 is modular and can be configured to function without the photovoltaic system 32 and charge control system 70. If used, the example photovoltaic system 32 comprises a plurality of PV arrays 72, and the example charge control system 70 comprises one charge controller 74 for each of the PV arrays 72. In particular, the output of the PV arrays 72 are connected to the charge controllers 74, and the charge controllers 74 are connected to the DC bus 62 such that a DC voltage generated by the PV arrays 72 is regulated at a voltage level defined by the second DC power signal as described above.

As depicted in FIG. 3, the example photovoltaic system 32 comprises six of the PV arrays 72a, 72b, 72c, 72d, 72e, and 72f, and the charge control system 70 comprises six charge controllers 74a, 74b, 74c, 74d, 74e, and 74f. More or fewer of these components 72 and 74 may be provided depending upon the load requirements of the load system 24 and the physical configuration of the solar bay 54 of the power system 20.

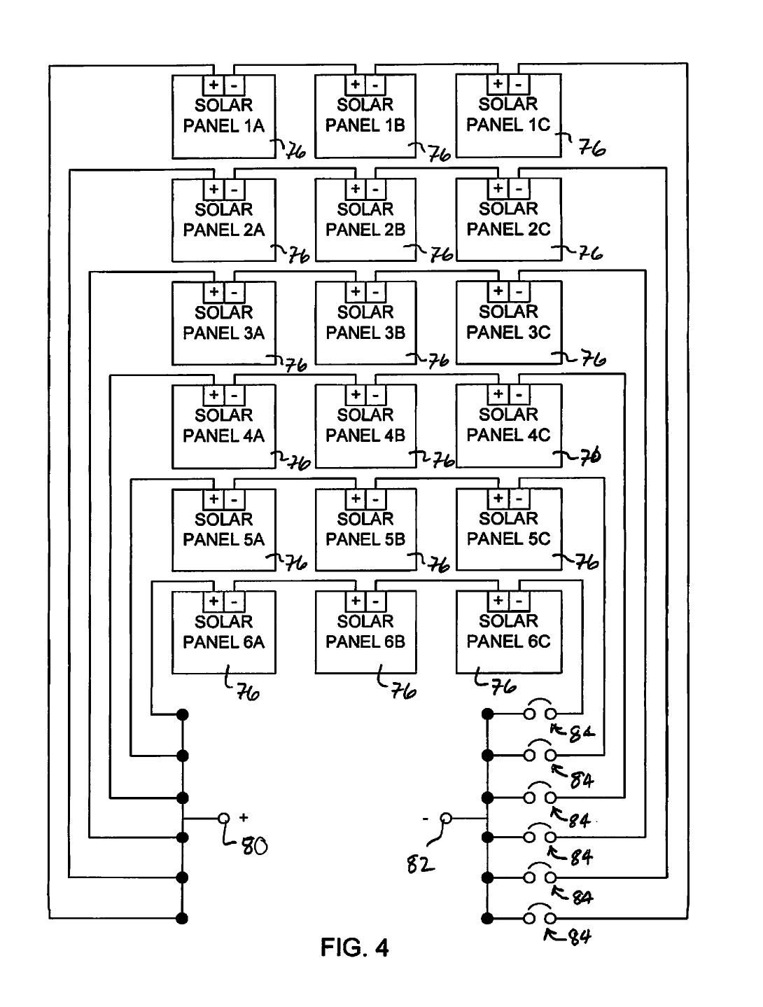

An example of one of the PV arrays 72 is depicted in FIG. 4. The example PV array 72 depicted in FIG. 4 comprises eighteen solar panels 76 connected to an array positive terminal 80 and an array negative terminal 82. In particular, each of the solar panels 76 generates a voltage level of approximately 30VDC depending upon factors such as the insolation levels. Three of the solar panels 76 are arranged in series to define a row having a voltage of approximately 90VDC, and six of the rows are arranged in parallel in a matrix to define a voltage of approximately 90VDC across terminals 80 and 82 of the PV array 72. While it is possible that fewer than six rows of the solar panels 76 may be used, in the example PV array 72 each row comprises three of the solar panels 76 to ensure that a voltage differential between the terminals 80 and 82 is appropriate for proper operation of the charge controllers 74. Circuit breakers 84 are arranged between the array negative terminal 82 and each of the rows of solar panels 76.

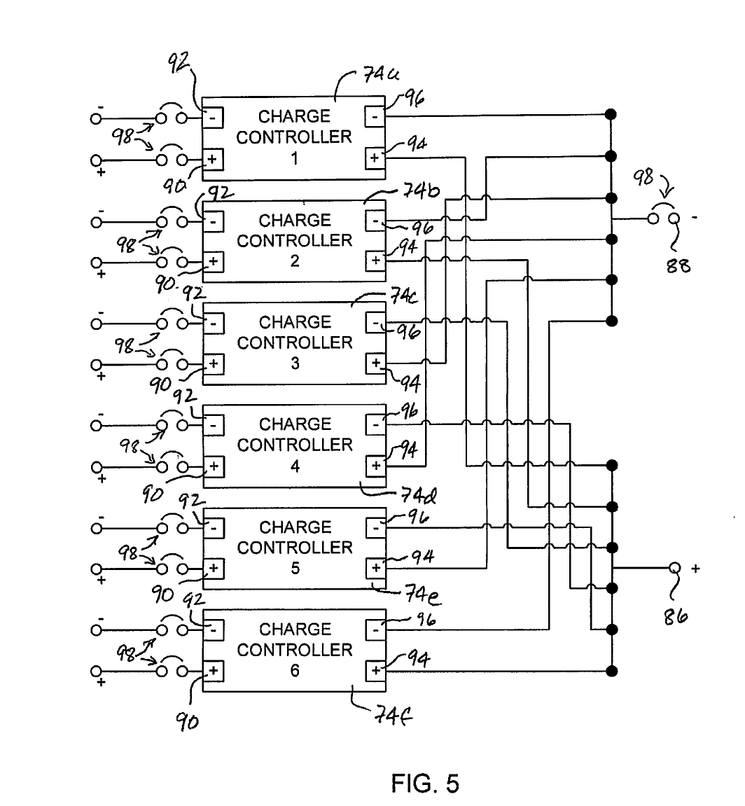

Referring now to FIG. 5, the charge controllers 74 of the example charge control system 70 are depicted in further detail. Each of the charge controllers 74 is connected to a charge control system positive terminal 86 and a charge control system negative output terminal 88. In particular, each charge controller 74 comprises a controller positive input terminal 90 and a controller negative input terminal 92. The controller positive input terminals 90 are connected to the array positive terminals 80 (FIG. 4), while the controller positive input terminals 92 are connected to the array positive terminals 82 (FIG. 4). Each of the charge controllers 74 further comprises a controller positive output terminal 94 and a controller negative output terminal 96. The controller positive output terminals 94 are connected to the charge control system positive output terminal 86, while the controller negative output terminals 96 are connected to the charge control system negative output terminal 88. Circuit breakers 98 are arranged at the input terminals 90 and 92 and at the charge control negative system output terminal 88.

When supplying power to the load system 24 from the photovoltaic system 32, the power system 20 transmits this power to the load system 24 with very high efficiency.

Given the foregoing, it should be apparent that the present invention may be embodied in forms other than those above. The scope of the present invention should thus be determined by the claims to be appended hereto and not the foregoing description of examples of the invention.

What is claimed is:

1. A power system for supplying electrical power to at least one load of a communications system based on at least one of a utility power signal, a solar power signal, and a battery power signal, comprising:
a rectifier module for generating a first DC signal based on the utility power signal;
a charge control system for generating a second DC signal based on the solar power signal;
a DC bus operatively connected to the first DC signal, the second DC signal, and the battery power signal; and
a distribution module operatively connected to the DC bus and a primary load of the communications system, where the distribution module supplies power to the primary load based on
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

2. A power system as recited in claim 1, in which a voltage level of the second DC signal is higher than a voltage level of the first DC signal.

3. A power system as recited in claim 1, further comprising an inverter module operatively connected to the DC bus and a secondary load of the communications system, where the inverter module supplies power to the secondary load based on:
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

4. A power system as recited in claim 1, in which the solar power signal falls outside the first operating range when the solar power signal is not present or is insufficient to meet the requirements of the at least one load of the communications system.

5. A power system as recited in claim 1, in which the combination of the first DC signal and second DC signal falls within the second operating range when the combination of the first DC signal and second DC signal is sufficient to satisfy the power requirements of the load system.

6. A power system as recited in claim 1, in which the combination of the first DC signal and second DC signal falls outside the second operating range when the combination of the first DC signal and second DC signal is not sufficient to satisfy the power requirements of the load system.

7. A method of supplying electrical power to at least one load of a communications system based on at least one of a utility power signal, a solar power signal, and a battery power signal, comprising the steps of:
generating a first DC signal based on the utility power signal;
generating a second DC signal based on the solar power signal;
operatively connecting the first DC signal, the second DC signal, and the battery power signal to a DC bus; and
supplying power to the primary load based on
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

8. A method as recited in claim 7, in which the first DC signal and the second DC signal are generated such that a voltage level of the second DC signal is higher than a voltage level of the first DC signal.

9. A method as recited in claim 7, further comprising the step of generating an inverter signal for supplying power to a secondary load of the communications system based on:
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

10. A method as recited in claim 7, further comprising the step of determining that the solar power signal falls outside the first operating range when the solar power signal is not present or is insufficient to meet the requirements of the at least one load of the communications system.

11. A method as recited in claim 7, further comprising the step determining that the combination of the first DC signal and second DC signal falls within the second operating range when the combination of the first DC signal and second DC signal is sufficient to satisfy the power requirements of the load system.

12. A method as recited in claim 7, further comprising the step determining that the combination of the first DC signal and second DC signal falls outside the second operating range when the combination of the first DC signal and second DC signal is not sufficient to satisfy the power requirements of the load system.

13. A communications system comprising a plurality of power systems each located at at least one of a plurality of communications facilities each comprising at least one load comprising:
a photovoltaic system for generating a solar power signal;
a battery system for generating a battery power signal;
a rectifier module for generating a first DC signal based on a utility power signal;
a charge control system for generating a second DC signal based on the solar power signal;
a DC bus operatively connected to the first DC signal, the second DC signal, and the battery power signal; and
a distribution module operatively connected to the DC bus and a primary load of the communications system, where the distribution module supplies power to the primary load based on
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

14. A communications system as recited in claim 13, in which a voltage level of the second DC signal is higher than a voltage level of the first DC signal.

15. A communications system as recited in claim 13, further comprising an inverter module operatively connected to the DC bus and a secondary load of the communications system, where the inverter module supplies power to the secondary load based on:
the second DC signal when the solar power signal falls within a first operating range;
at least one of the first DC signal and the second DC signal when the solar power signal falls outside of the first operating range and a combination of the first DC signal and the second DC signal falls within a second operating range;
at least one of the second DC signal and the battery power signal when the solar power signal falls within the first operating range and the combination of the first DC signal and second DC signal falls outside the second operating range; and
the battery power signal when the solar power signal falls outside the first operating range and the combination of the first DC signal and second DC signal falls outside the second operating range.

16. A communications system as recited in claim 13, in which the solar power signal falls outside the first operating range when the solar power signal is not present or is insufficient to meet the requirements of the at least one load of the communications system.

17. A communications system as recited in claim 13, in which the combination of the first DC signal and second DC signal falls within the second operating range when the combination of the first DC signal and second DC signal is sufficient to satisfy the power requirements of the load system.

18. A communications system as recited in claim 13, in which the combination of the first DC signal and second DC signal falls outside the second operating range when the combination of the first DC signal and second DC signal is not sufficient to satisfy the power requirements of the load system.

19. A communications system as recited in claim 13, in which the battery is charged when the first DC signal and second DC signal falls within the second operating range.

20. A communications system as recited in claim 13, in which the photovoltaic system comprises:
a plurality of solar panels arranged in a plurality of photovoltaic arrays; and
a plurality of charge controllers, where each charge controller is operatively connected between one of the pluralities of photovoltaic arrays and the DC bus.
